(19) United States
(12) Patent Application Publication
(10) Pub. No.: US 2023/0174400 A1
(43) Pub. Date: Jun. 8, 2023

(54) Systems and Methods for Reducing Pollutants, Including Carbon in Public Utilities, Agriculture and Manufacturing

(71) Applicant: Advanced Innovators Inc., Fleming Island, FL (US)

(72) Inventor: Robert Whiteman, Fleming Island, FL (US)

(73) Assignee: Advanced Innovators Inc., Fleming Island, FL (US)

(21) Appl. No.: 17/877,941

(22) Filed: Jul. 30, 2022

Related U.S. Application Data
(60) Provisional application No. 63/227,979, filed on Jul. 30, 2021.

(51) Int. Cl. C02F 3/34; C02F 3/30

(52) U.S. Cl. CPC C02F 3/341; C02F 3/302; C02F 3/343; C02F 2101/32; C02F 2209/40

(57) ABSTRACT

A method of providing, maintaining and using a youthful added microbe population for the treatment of wastewater. A method of providing green sustainable microbiology net zero carbon solution to waste water and waste material treatment using biofermentation to treat the waste water and waste material with aa treatment containing biofermented microbes.

This application claims priority to and under 35 U.S.C. §119(e)(1) the benefit of the filing date of U.S. Provisional Application Serial No. 63/227,979, filed Jul. 30, 2021, the entire disclosure of which is incorporated herein by reference.

### BACKGROUND OF THE INVENTION

### Field of the Invention

The present inventions relate to novel and unique application and uses for bioremediation and waste materials, including municipal and manufacturing waste materials, including water streams.

In general wastewater treatment systems handle effluent from municipalities, industrial sites, factories, storm drainage systems and other locations where water that has been contaminated with undesirable materials is present. As used herein, unless stated otherwise the term “wastewater treatment system”, “wastewater treatment facility”, “treatment facility”, and similar such terms, should be given its broadest possible meaning and would include: industrial and municipal systems having primary treatment, secondary treatment or tertiary treatment and combinations and variations of these; aerobic, facultative, or anaerobic biological wastewater systems; aerobic processes include, for example, activated sludge systems, aerobic stabilization basins (ASB), aerated lagoons, single pass lagoon systems, stabilization ponds, rotating biological contactors, and trickling filters; facultative processes include, for example, facultative lagoons; anaerobic processes include, for example, anaerobic ponds, anaerobic digesters, anaerobic filters or contactors, and anaerobic treatment systems; systems having clarifiers, settling tanks, digesters, activated sludge systems, lagoons, single pass lagoons, and combinations and variations of these; systems such as activated sludge systems, rotating disc systems, submerged aerated filter, suspended media filters, sequencing batch reactors non-electric filters and trickling filters; and combinations and variations of these and other device for cleaning wastewater.

Wastewater treatment plants can range from small volumes per day, measures in flow per day, i.e., gallons per day (GPD) to large volumes measured in flows of million (1,000,000) gallons per day (MGD). The flow can be 10 s, 100 s, 1,000 s, 10,000 s, and 100,000 s of GPD. Typically, for municipal and industrial sites, the flow of wastewater is about 0.01 MGD and greater, about 0.1 MGD and greater, about 1 MGD and greater, about 2 MGD and greater, from 0.01 MGD to 100 MGD, from 0.05 MGD to 50 MGD, from 0.1 MGD to 2 MGD, from about 1 MGD to about 15 MGD, from about 5 MGD to about 25 MGD, from about 10 MGD to about 40 MGD, from about 20 MGD to about 100 MGD, from about 25 MGD to about 60 MGD, from about 200 MGD to about 300 MGD, about 300 MGD and greater, about 350 MGD and greater and greater and smaller, flows as well as, all flows within these ranges.

The capacity or size of a wastewater treatment plant can also be measured in Population Equivalent (“PE”). PE is standardization that is used to measure flow, and compare flow between different treatment plants. PE is the number expressing the ratio of the sum of pollution load produced during 24 hours by industry facilities and service to the individual population in household sewage produced by one person in the same time.

$$P E = \frac{B O D l o a d f r o m i n d u s t r y \left[\frac{k g}{d a y}\right]}{0.054 \left[\frac{k g}{i n h a b ⋅ d a y}\right]}$$

Typically, one unit of PE is equal to 54 grams of BOD per 24 hours. In flow, as used herein a unit of PE equates to 50 gallons per person per day or 200 liters per person per day. Wastewater treatment plants can have capacities of 10,000 to 200,000 PE, 50,000 to 100,000 PE, 50,000 to 500,000 PE, 100,000 PE to 2,000,000 (2 mm) PE, 1 mm PE to 4 mm PE, 150 mm PE and greater, 200 mm PE and greater, and about a 300 mm PE and all capacities within these ranges, and greater and smaller capacities. In addition, the plants can be sized larger than their PE to address storm surges.

In general, absent expensive and sometimes unreliable treatment equipment or processes, such as sludge stabilization equipment, the sludge or waste sludge or biosolids which terms are used as synonymous terms herein unless expressly stated otherwise, that is produced by the wastewater treatment system typically contains undesirable material that requires further costly and environmentally less desirable disposal techniques. These processes require large capital expenditure and have high operating costs along with high carbon footprints, use harsh and dangerous materials, such as caustic and acidic chemicals, as well as other disadvantageous requirements. In particular, the latter prior pH-based systems, as well as other prior disinfections systems, have proven to be unreliable, undesirable and have not met the needs for the production of safe, usable, and economically and environmentally acceptable sludge and other such end of process materials. Other less capital intensive variations, such as composting, nevertheless have disadvantages of using fillers such as bark, which might be contaminated with legislated fecal matter making standards for fecals more difficult to meet.

As used herein, unless specifically stated otherwise, the term “influent” should be given it broadest possible meaning, and refers to wastewater or other liquid-raw (untreated) or partially treated-flowing into a device, system, apparatus, reservoir, basin, treatment process treatment system, treatment device, tank, or treatment plant or treatment facility.

As used herein, unless specifically stated otherwise, the term “sludge” should be given its broadest possible meaning, and would include the material that is removed from wastewater by a wastewater treatment plant. Typically, sludge can have from about 0.2% to about 80% solids, about 1% to about 60% solids, about 0.25% to 0.5% solids, about 2% to about 4% solids, about 50% to about 99% solids, about 5% to about 25% solids, about 5% solids, about 10 % solids, about 1% solids, about 10% solids, about 15% solids, greater than about 0.5% solids, greater than about 2% solids, greater than about 5% solids, and combinations and variations of these as well as all values within these ranges.

As used herein, unless specifically stated otherwise, the terms “floc forming microbes”, “floc formers” , floc forming, and similar such terms should be given their broadest possible meaning, including a generic group of microbes that cause floc formation or flocculate resulting in large clumps or communities of bacteria working together; including: floc forming bacteria, Achromobacter, Flavobacterium, Alcaligenes, Arthrobacter, Zooglea, Acinetobacter, Citromonas; predators: protozoa, rotifers, nematodes Vorticella, Aspicidica, Paramecium; Phosphate accumulating organisms (PAO), algae (lagoons).

As used herein, unless specifically stated otherwise, the term “greenhouse gas” and similar such terms include any gas that contributes to global warming or temperature raise when in the atmosphere. Such gases would include carbon dioxide (CO₂), methane (CH₄) and Nitrous Oxide (N20). N20 has about a 300 times more determinantal effect of global warming than CO₂. Equivalent.

As used herein, unless stated otherwise, room temperature is 25° C. And, standard temperature and pressure is 25° C. and 1 atmosphere.

Generally, the term “about” as used herein unless specified otherwise is meant to encompass the greater of a variance or range of ±10%, or the experimental or instrument error associated with obtaining the stated value.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

### SUMMARY

There has been a long standing and developing need for methods and apparatus to remove and eliminate pollutants from waste materials, including waste water, that are produced by the humans, urban and rural living settings, agriculture and manufacturing activities. Along these lines there is an ever increasing need to reduce the amount of greenhouse gases, including CO₂ that are produced by such activities, and a long standing and increasing need to make these activities carbon neutral. The present inventions, among other things, solve these needs by providing the compositions of matter, materials, articles of manufacture, devices and processes taught, disclosed and claimed herein.

Globally, wastewater treatment represents 3% of carbon dioxide emissions or 31.5 billion tons a year. For over 100 years the solution to growing populations and the demand for wastewater treatment has been to build capital facilities and energy-intensive processes to contain nature’s biology. The goal is to remove total suspended solids (TSS), organics measured as Biochemical Oxygen Demand (BOD), plus sources of nutrients such as nitrogen (N) and phosphorus (P) prior to discharging clean water. The energy intensive processes increase our carbon footprint and adds to our collective climate crisis. The present inventions solve these, as well as other problems, by providing the treatment facilities and methods of operation of those facilities that are set forth in this specification.

Prior to the present inventions, there only existed expensive, complex engineering solutions to address the biosolids handling issues. All these processes are capital intensive with significant “embodied carbon” in the structures, which is most often overlooked. Furthermore, the overall processing, handling, and disposal of biosolids can represent as much as 30-40% of the operating budget of a utility. The present inventions address these problems and reduce the carbon footprint for all these processes from 20% to 60%, and potentially more, as well as reducing the need for new capital investment.

Prior to the present inventions the use of added microbes (e.g., bacteria) to a wastewater treatment system was understood to provide some, but not a highly effective, benefit in removing pollutants from wastewater. It is believed that prior to the present inventions, these added microbe type technologies, were not know to, understood to, or implemented to reduce the carbon-footprint of a wastewater treatment facility or to reduce the production of greenhouse gasses from that facility.

The use of treatment batches of active microbes grown on-site, or provided on-site, for use in wastewater treatment facilities provide significant benefits in reducing the pollution in effluent coming from a treatment facility. A preferred type of these “active treatment batch” approaches (e.g., systems, methods, methodologies and technologies) are taught and disclosed in U.S. Pat. Nos. 11,155,484, 9,409,803 and 7,879,593, the entire disclosure of each of which is incorporated herein by reference. A particularly preferred type of active treatment batch approaches are Biofermentation° approaches, which are taught and disclosed in U.S. Pat. Nos. 11,155,484, 9,409,803 and 7,879,593. These approaches have been used to address, for example: problems in the operations of wastewater facilities; increased pollution in the influent; a facility being out of balance; increasing the purity of the effluent (i.e., reducing the pollutants in the effluent); reducing the amount of sludge produced while maintaining the purity of the effluent; and, providing sludge that has reduced levels of contaminates, e.g., Class A sludge.

Prior to the present inventions, the configuration of, implementation of, and use of active treatment batch methodologies and technologies, e.g., Biofermentation° methodologies and technologies had not been known, understood or implemented: reducing the carbon-footprint of a wastewater treatment facility; breaking the paradigm of increased effluent purity requiring increased greenhouse gas production; and combinations and variations of these and other benefits. The present inventions provide surprising new uses for, applications for, and configurations of, active treatment batch methodologies and technologies, e.g., Biofermentation° methodologies and technologies, which, among other things: reduce the carbon-footprint of wastewater treatment plants; increase the purity of wastewater effluent without increasing the production of greenhouse gasses; breaking the paradigm linking increased effluent purity with increased carbon-footprint and increased greenhouse gas production; as well as, other benefits and advantages set for in this Specification.

Thus, there is provided a method of increasing a capacity of a wastewater treatment facility, while maintaining the quality of the effluent, and without increasing a carbon footprint of the wastewater treatment plant, the method comprising: determining an initial flow rate of a wastewater treatment facility; the wastewater treatment facility having an embodied carbon footprint; wherein the initial flow rate is at a capacity of the embodied carbon footprint to maintain the pollutants in an effluent from the wastewater treatment plant at or below a first level of pollutants; and, increasing the flow rate of the wastewater treatment facility to provide an increased flow rate, wherein the increased flow rate is at least 25% greater than the initial flow rate; wherein the level of pollutants in the effluent are maintained at or below the first level of pollutants at the increased flow rate; and, wherein, the embodied carbon footprint of the wastewater treatment facility remains the same.

Further, there is provided a method of providing green sustainable microbiology net zero carbon solution to waste water and waste material treatment using biofermentation to treat the waste water and waste material with a treatment containing biofermented microbes.

Additionally, there is provided a method of operating a wastewater treatment facility, to reduce the production of greenhouse gasses associated with the treatment of the wastewater, while maintaining the quality of the effluent, and without reducing the capacity of the wastewater treatment plant, the method comprising: the wastewater treatment facility producing a first amount of greenhouse gasses for the treatment and disposal of sludge having for an initial flow rate of the wastewater treatment; wherein the pollutants in an effluent from the wastewater treatment plant are maintained at or below a first level of pollutants; and, reducing the first amount of greenhouse gasses produced by at least 25%, while maintaining the level of pollutants in the effluent at or below the first level of pollutants.

Yet additionally there is provided these methods, and systems for operating these methods, having one or more of the following features: wherein the increased flow rate is at least 20% greater than the initial flow rate; wherein the increased flow rate is at least 50% greater than the initial flow rate; wherein the increased flow rate is at least 70% greater than the initial flow rate; wherein the amount of biosolids produced from treating the initial flow rate to the increased flow rate is reduced by at least 25%; wherein the amount of biosolids produced from treating the initial flow rate to the increased flow rate is reduced by at least 50%; wherein the amount of biosolids produced from treating the initial flow rate to the increased flow rate is reduced by at least 60%; wherein the amount of phosphorous produced from treating the initial flow rate to the increased flow rate is reduced by at least 20%; wherein the amount of phosphorous from treating the initial flow rate to the increased flow rate is reduced by at least 50%.; wherein the amount of nitrogen produced from treating the initial flow rate to the increased flow rate is reduced by at least 20%; wherein the amount of nitrogen from treating the initial flow rate to the increased flow rate is reduced by at least 50%; wherein the greenhouse gasses are reduced by at least 30%; wherein the greenhouse gasses are reduced by at least 40%; wherein the greenhouse gasses are reduced by at least 60%.; wherein the greenhouse gasses are reduced by at least 80%; wherein the amount of biosolids produced from treating the initial flow rate to the increased flow rate is reduced by at least 50%; wherein the amount of biosolids produced from treating the initial flow rate to the increased flow rate is reduced by at least 60%; wherein the amount of phosphorous produced from treating the initial flow rate to the increased flow rate is reduced by at least 20%; wherein the amount of phosphorous from treating the initial flow rate to the increased flow rate is reduced by at least 50%; wherein the amount of nitrogen produced from treating the initial flow rate to the increased flow rate is reduced by at least 20%; comprising the treatment of fats, oils and grease; comprising increasing alkalinity recovery by improving denitrification; comprising improving biomass settleability; comprising control of undesirable filamentous growth; comprising improving nitrification and increasing ammonia removal; comprising re-rating wastewater plants; comprising increasing capacity and hydraulic throughput of wastewater plants; comprising increasing.

### BRIEF DESCRIPTION OF THE DRAWINGS

FIG. 1 is a chart showing the impact of an embodiment of an activated active treatment batch approach on embodied carbon footprint of a an embodiment of a design or proposed treatment facility in accordance with the present inventions.

FIG. 2 is a chart showing the impact of an embodiment of an activated active treatment batch approach on embodied carbon vs operating carbon in accordance with the present inventions.

FIG. 3 is a chart showing the impact of an embodiment of an activated active treatment batch approach on total carbon footprint in accordance with the present inventions.

FIG. 4 is a chart showing the impact of an embodiment of an activated active treatment batch approach on land application practices in accordance with the present inventions.

FIG. 5 is a chart showing the impact of an embodiment of an activated active treatment batch approach on incineration practices in accordance with the present inventions.

FIG. 6 is a chart showing the impact of an embodiment of an activated active treatment batch approach on increasing phosphorous removal in accordance with the present inventions.

FIG. 7 is a chart showing the impact of an embodiment of an activated active treatment batch approach on increased capacity and hydraulic throughput in accordance with the present inventions.

FIG. 8 is a chart showing the impact of an embodiment of an activated active treatment batch approach on improving ammonia-nitrogen removal in accordance with the present inventions.

FIGS. 9A and 9B are charts showing the impact of an embodiment of an activated active treatment batch approach on improved settleability an control of filamentous growth in accordance with the present inventions.

FIGS. 10A and 10B are charts showing the impact of an embodiment of an activated active treatment batch approach on recovery of alkalinity via improved denitrification in accordance with the present inventions.

FIG. 11 is a chart showing electrical consumption per activity in an embodiment of a wastewater treatment facility.

FIG. 12 is a chart showing embodiments of carbon contributions by process in an embodiment to a wastewater treatment facility.

FIG. 13 is a chart showing an embodiment of improvements in energy usage reduction in accordance with the present inventions.

### DESCRIPTION OF THE PREFERRED EMBODIMENTS

In general, the present inventions relate to systems, apparatus and processes for treating wastewater and waste materials to reduce the amount of pollutants, including greenhouse gases that are present and in particular that are released into the environment. Thus, embodiments of the present inventions relate to the treatment of wastewater and waste materials with biological materials, systems and methods for preforming such treatments, and the production from wastewater of useful, safe and environmentally acceptable materials, including liquids. Apparatus, equipment, systems, treatments and biofermentation methods of the type taught and disclosed in U.S. Publ. No 2020/0087183, the entire disclosure of which is incorporated by reference, can be used in the present inventions to provide the benefits and advantages of the present inventions,

Although this specification primarily focusses on municipal waste water treatment plants, the present inventions are not so limited. Embodiments of the present systems and methods set forth in this specification find use, applicability and provide benefits to industrial waste water treatment plants, such as those in the pulp and paper industries, mining industries, and commercial (factory) farming and livestock facilities.

Embodiments of the present systems, devices and methods are capable of obtaining low greenhouse gas (e.g., CO₂ N2O and CH₄) production and generation, and are capable of operating in a net carbon neutral manner.

Embodiments of the present inventions are able to provide increased purity of effluent streams, without increasing the greenhouse gas production, associated with the treat facility. Thus, embodiments of the present inventions provide increased effluent purity, i.e., reduced pollutants, without increasing the production of greenhouse gases, and preferably with a reduction of greenhouse gasses.

As environmental quality standards (EQS) for waste water are increased in the US and around the world, secondary or additional treatment processes and equipment have generally been required to meet these increase standards. These additional treatment measures require increase energy use, both thorough the building of larger or additional facilities, included increased cement usage, as well as, increased energy usage to operate these additional facilities, processes or treatment apparatus. Thus, meeting ever higher EQS creates an unfortunate, and prior to the present inventions, unsolvable paradigm, while effluent water quality is increased, it comes at the cost of an increased carbon-footprint and greenhouse gas pollution. The present inventions address and overcome this paradigm. Embodiments of the present inventions enable higher ESO standards to be meet, i.e., cleaner effluent from wastewater treatment facility, without the need for prior additional measures and the resulting increases in carbon-foot print ana greenhouse gasses associated with those additional measures.

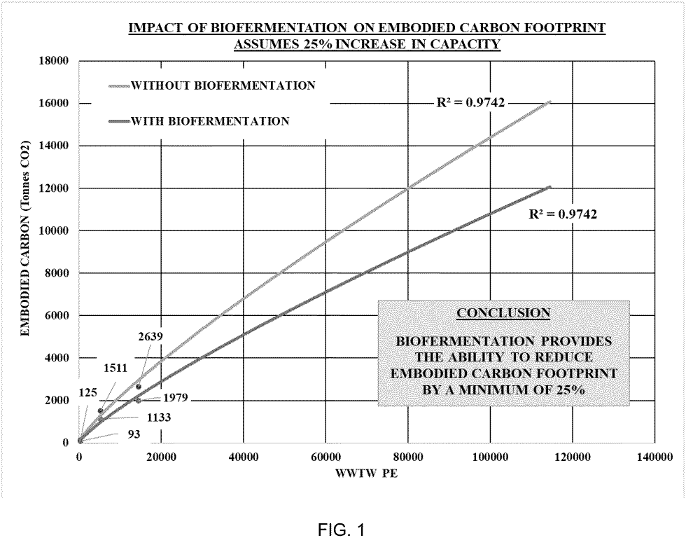

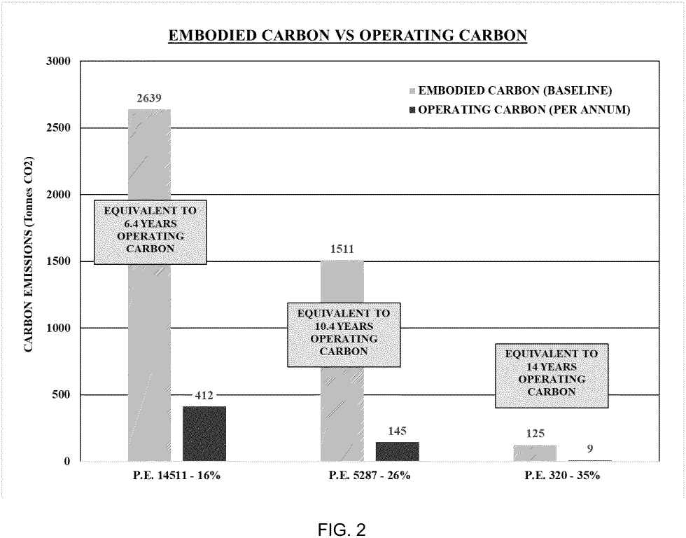

In general, embodiments of the present inventions provide for the construction of a new treatment facility that can be built having the same or better through put capacity and effluent quality with a significant reduction in carbon-footprint as shown in FIG. 1. Thus, for example a treatment facility constructed to use an active treatment batch approach can conservatively increase capacity 25%, thereby reducing embodied carbon of design and new construction by at least 25%. For an existing treatment facility an example of saving in carbon-footprint is further illustrated by FIG. 2 by eliminating the need for construction yet increase capacity by 25%. For example, the largest challenge for a treatment facility having 200-300 MGP flow is to increase capacity of the treatment facility by 25% in the next 25 years, which means all or most of the planned capital expenditure for expansion or embodied carbon could be simply eliminated. Thus, for example embodied carbon represents 6.4 to 14 years of operating carbon emissions for plant treating a PE of 14,500 to 300.

Embodiments of the present invention provide for increased capacity of the treatment facility, over extend periods of time, e.g., next 10 years, next 20 years, next 25 years, without increasing the embodied carbon footprint. Such increases in capacity can be 25% or more, 30% or more, and 50% or more. This invention does not limit its claim to only increasing capacity by 25%, this is merely an example. These operational configurations and methods of increasing capacity without increasing the carbon footprint (e.g, embodied carbon footprint) can be implemented in wastewater treatment plants having capacities of 10,000 to 200,000 PE, 50,000 to 100,000 PE, 50,000 to 500,000 PE, 100,000 PE to 2 mm PE, 1 mm PE to 4 mm PE, 150 mm PE and greater, 200 mm PE and greater, and about a 300 mm PE, and all values within these ranges.

Embodiments of the present invention provide for increased capacity of the treatment facility, over extend periods of time, e.g., next 10 years, next 20 years, next 25 years, without increasing the embodied carbon footprint. Such increases in capacity can be 25% or more, 30% or more, and 50% or more. This invention does not limit its claim to only increasing capacity by 25%, this is merely an example. These operational configurations and methods of increasing capacity without increasing the carbon footprint (e.g, embodied carbon footprint) can be implemented in wastewater treatment plants having wastewater flow rates of about 0.01 MGD and greater, about 0.1 MGD and greater, about 1 MGD and greater, about 2 MGD and greater, from 0.01 MGD to 100 MGD, from 0.05 MGD to 50 MGD, from 0.1 MGD to 2 MGD, from about 1 MGD to about 15 MGD, from about 5 MGD to about 25 MGD, from about 10 MGD to about 40 MGD, from about 20 MGD to about 100 MGD, from about 25 MGD to about 60 MGD, from about 200 MGD to about 300 MGD, about 300 MGD and greater, about 350 MGD and greater and greater and smaller, flows as well as, all flows within these ranges.

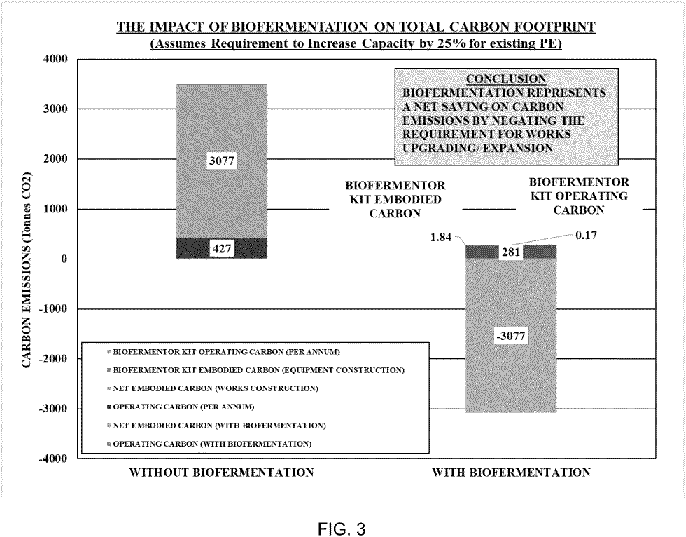

In general, embodiments of the present invention relate to wastewater treatment facilities that use and optimize active treatment batch methodologies and technologies and thus and eliminate significant embodied carbon emissions The embodied carbon footprint of such a facility is 4 magnitudes less than engineering solutions (e.g., added size and processes need to obtain same quality and throughput) The operating carbon footprint of such systems is 3 magnitudes less, and better, than engineering solutions. The implementation, operation and benefits of such a facility are further shown in FIG. 3.

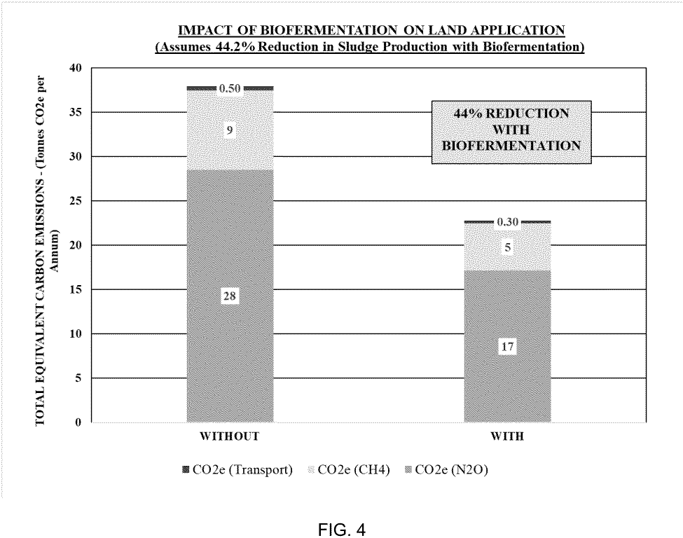

In general, embodiments of the present inventions relate to land fill design and operation that reduce greenhouse gases. Thus, active treatment batch methodologies and technologies reduce sludge production by at least 44% which would proportionally impact (e.g., reduce) release of NOX and methane from landfill applications that are used as the disposal route. The implementation, operation and benefits of such a facility are further shown in FIG. 4.

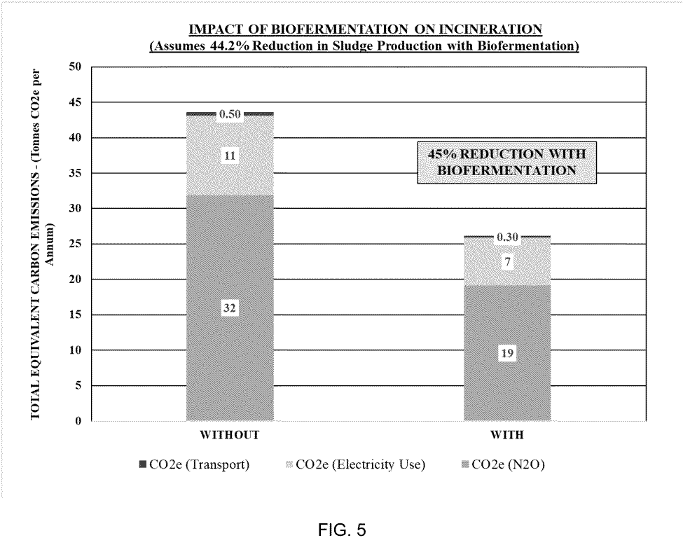

In general, embodiments of the present inventions relate to sludge incineration operation that reduce greenhouse gases. Thus, active treatment batch methodologies and technologies reduce sludge production by at least 44% which would proportionally impact (e.g., reduce) release of CO₂ and NOX from sludge incineration applications that are used as the disposal route. The implementation, operation and benefits of such a facility are further shown in FIG. 5.

In general, embodiments of the present invention relate to methods of reduced greenhouse gas emission in the treatment of wastewater and the disposal of sludge produced from this treatment. Thus, embodiments of the present inventions provide a total, i.e., start to finish, reduction in greenhouse gasses for the treatment of wastewater, and in particular the treatment of municipal wastewater.

Thus, in general, embodiments of the present inventions relate to embodiments of wastewater management utilizing active treatment batch methodologies and technologies to provide a solution for utilities and operators to reduce greenhouse gas emissions, and meet national, regional and global regulatory and organizational zero, or low, carbon guidelines, rules or standards, from existing facilities, as well as, newly constructed facilities, among other benefits.

In general, embodiments of the present inventions relate to a wastewater treatment facility configured, built, retrofitted, operated, and combinations and variations of these, for implementation of treatment batches of active microbes grown on-site, or provided on-site. (The active microbes in the treatment batch, it is theorized function in a synergistic manner, similar to probiotics in the gut of a mammal) The treatment batch can be grown on site at the treatment facility or at a location near to the treatment facility, so that a liquid treatment batch containing living, active microbes is provided into the wastewater in the facility at one or more application points.

A preferred type of these liquid active treatment batch approaches (e.g., systems, methods, methodologies and technologies) are taught and disclosed in U.S. Pat. Nos. 11,155,484, 9,409,803 and 7,879,593. A particularly preferred type of active treatment batch approaches are Biofermentation° approaches, which are taught and disclosed in U.S. Pat. Nos. 11,155,484, 9,409,803 and 7,879,593. Liquid active treatment batch approaches utilize a reactor, method and process for growing microbial cultures either on-site as a side stream reactor or at a nearby off-site facility, to provide the liquid treatment batch. Preferably these approaches avoid a freeze-drying or preservation step prior to addition of the microbial culture to the reactor to grow the treatment batch, which can have a very high kill rate, probably 99.9%.

Generally, the microbes in the liquid treatment batch can be any useful microbe for the treatment of wastewater, and preferably are selected from one or more of the floc forming microbes. In general, the liquid treatment batch can be added to one or more locations in the wastewater treatment facility including: activated sludge systems, aerobic stabilization basins (ASB), aerated lagoons, single pass lagoon systems, stabilization ponds, rotating biological contactors, and trickling filters; facultative processes include, for example, facultative lagoons; anaerobic processes include, for example, anaerobic ponds, anaerobic digesters, anaerobic filters or contactors, and anaerobic treatment systems; systems having clarifiers, settling tanks, digesters, activated sludge systems, lagoons, single pass lagoons, and combinations and variations of these; systems such as activated sludge systems, rotating disc systems, submerged aerated filter, suspended media filters, sequencing batch reactors non-electric filters and trickling filters; and combinations and variations of these and other device for cleaning wastewater. A preferred type of these active treatment batch approaches (e.g., systems, methods, methodologies and technologies) are taught and disclosed in U.S. Pat. Nos. 11,155,484, 9,409,803 and 7,879,593, the entire disclosure of each of which is incorporated herein by reference.

Generally, the microbes in the liquid treatment batch for use in the present embodiments can be one or more strain, type or species of microbe. The term microbe, as used herein, include fungus, yeast, bacteria, and other biodegrading small unicellular organisms. For example, the microbes can be floc forming microbes. Some additional examples of microbes with particular biodegradation characteristics, for use in the liquid treatment batch, are provided in Table 1.

TABLE 1

| | | | |
|---|---|---|---|
| Microbe | Respiration Type | Application Example | End Product Example |
| Pseudomonas putida | Aerobic | Phenol, toluene | Water, CO₂,biomass |
| Bacillus subtilis | Aerobic | Starch | Water, CO₂,biomass |
| Nocarida spp. | Aerobic | Cyclohexane | Water, CO₂,biomass |
| White Rot Fungus spp. | Aerobic | Chloro-organics | Water, CO₂,biomass |
| Nitrosomonas spp. | Aerobic | Ammonia oxidation | Nitrite |
| Nitrobacter spp. | Aerobic | Nitrite oxidation | Nitrate |
| Thiosphera pantotropha | Aerobic | Denitrification | Nitrogen gas |
| Methanogenic bacteria | Anaerobic | Acetic acid | Methane, CO₂, biomass |

Notes: Spp.=species, these can vary; Subtilis is one species of Bacillus; Putida is one species of Pseudomonas; CO₂=carbon dioxide.

Additional examples of microbes, that may be used in the liquid treatment batch, include Bacillus, Bacillus subtilis, Pseudomonas , e.g., Pseudomonas putida, and Nocardia strains, as well as other strains for the biodegradation of hydrocarbons that are documented in “Developments in Biodegradation of Hydrocarbons-1” by Watkinson, Applied Science Publishers, 1978 ISBN: 0-85334-751-4, which is incorporated herein by reference. Chloro-organics biodegradation using White Rot Fungus is well documented in U.S. Pat. No. 4,554,075, which is incorporated herein by reference. Culture methods are discussed in increasing Ligninolytic Enzyme Activities in Several White-Rot Basidiomycetes by Nitrogen Sufficient Media″ Erwin etal, Biosource Technology, Volume 53, (1995), pages 133-139, Elsevier Science Limited, which is incorporated herein by reference.

Generally, the liquid treatment batch as initially grown can have a concentration of microbes from about 10⁷ - 10¹⁰ colony forming units per milliliter (cfu/ml), about 10⁸ - 10⁹ cfu/ml, about 10⁷ cfu and greater, about 10⁹ cfu and greater. When grown on-site these treatment batches can be directly added to the wastewater. These treatment batches can further be concentrated, in a manner that keeps the microbes alive and active, and then supplied to the wastewater in the treatment plant. The concentration of these treatment batched can be 2x to 400x greater, about 4x greater, about 20x greater, about 40x greater, about 100x greater, about 200x greater, about 10x to 100x greater, and about 300x to about 400x greater than the liquid treatment batch as initially grow (i.e., about 10⁸ - 10⁹ cfu/ml) and all value within these ranges. These liquid concentrated treatment batches are then added to the wastewater within 24 hours of manufacture, within up to 48 hours of manufacture, within up to 72 hours of manufacture or within one week of manufacture or variations thereof.

The volume of a treatment batch added to a particular treatment system (e.g., dosage, or dosing rate, dosage rate) is dependent on factors such on flow, PE, both organic and hydraulic loading rate, the rapidity or response required, the challenges faced, industrial discharges at municipal plants severely increased apparent load, the presence of toxicity or toxic compounds killing the existing biology, results desired and the concentration of liquid being applied and the type of plant. For example, activated sludge plants with MCRT’s of greater than 7 days the treatment batch can be applied weekly, whereas a single pass lagoon should be added continuously for best results, while a trickling filter would preferably be added daily. As previously mentioned, the concentration of a treatment batch can vary from 1x, to 400x and so volumes can vary accordingly. In general, using 4X as a basis the volumes for treating 1 MGD of flow would be between 100 and 400 gallons per week of the liquid treatment batdch. For a PE of 14,500 a dosing rate of between 1,500-5,000 litres per week at 4X is effective.

Further, and for example, a treatment plant having a PE of 14,500 is treated at 3,000 litre per week at 4x treatment batch concentration. A 6 GPM is treated with 200 gallon per week, at 4x treatment batch concentration.

Thus, the dosage rates for a 4x concentration can range for about 50 gallons per week to 400 gallons per week, from about 100 gallons per week to about 300 gallons per week, from about 200 gallons per week to 400 gallons per week, about 50 gallons per week or more, about 100 gallons per week or more, about 150 gallons per week or more, about 500 gallons per week or more, about 1,000 gallons per week (e.g, for 10-50 MGD plant) or more, and all values within these ranges, as well as greater and small amounts. In general, as concentration increases dosage rate (e.g., amount per week) of the liquid treatment batch decreases proportionally. Similarly, as PE increases and flow rate increase, dosage rate of the liquid treatment batch will increase.

In general, embodiments of the present inventions relate to a novel and unique process referred to as “Advanced Digestion”. Advanced Digestion involves embodiments of the present inventions which relate to embodiments of the present active treatment batch approach to an aerobic digester to increase microbial viability during the death phase or reduction in sludge, which involves breakdown of the sludge/existing biology. This results in release of ammonia, which aerobically converted to nitrate by Nitrifying bacteria. The decant from aerobic digesters is normally returned to the head of the wastewater treatment facility adding a nitrogen load of ammonia and/or nitrate. Advanced Digestion cycles the air on/off in the digester to allow for facultative or anoxic conditions to occur in which nitrate is used by bacteria to breakdown more sludge. Eventually, when nitrate runs out the sludge goes into an anaerobic phase which can be sued to breakdown more sludge to release more ammonia or the aeration can be switched back on to start the nitrification/denitrification cycle again. This has allows operation of the digester without the need to waste or haul sludge for extend periods of time, e.g., 60 months or reducing overall sludge processing and handling by 90%+/- 5%, while reducing sludge hauling, thereby reducing carbon footprint for downstream processing, handing and final disposal. The carbon footprint of aeration is reduced by between 30-70% depending on the nature of the sludge and aerobic, anoxic and anaerobic phases the digester is cycled through.

In general, embodiments of the present inventions relate to embodiments of the present active treatment batch approach and treatment facilities, can be configured to and operated under one or more of the parameters in Table 2.

TABLE 2

| Problems and Solutions | Improvement | Reduced CO₂ emissions |
|---|---|---|
| Increased PE Capacity | 125%+ | 25-40%+ |
| Consent Compliance | Within 10 Days | 25-40%+ |
| Reduced CAPEX Requirement | 50%+ | 25-40%+ |
| Reduced OPEX Requirement | 20%+ | 25-40%+ |
| Reduced Energy Requirement | 10-20%+ | 25-40%+ |
| Increased Hydraulic Capacity | 125-150%+ | 25-40%+ |
| Increased Organic Capacity | 125-150%+ | 25-40%+ |
| Increased Resilience | Significant increase | 25-40%+ |
| Eliminated Filamentous Bulking | Elimination | 25-40%+ |
| Reduced Nitrogen | 50%+ | 25-40%+ |
| Reduced Phosphorus | 50%- | 25-40%+ |
| Reduced Biosolids (Sludge) | 60%+ | 25-40%+ |
| Advanced Digestion | 90%+ | 25-40%+ |
| Class A Residuals (USA) | Optional benefit | 25-40%+ |
| Reduced FOG in Collection | Significant | 25-40%+ |
| Improved Odor Control | Significant | 25-40%+ |
| Improved Algae Control | Significant | 25-40%+ |
| Improved Fly Nuisance Control | Significant | 25-40%+ |

The parameters for assessing or deterring the reduction of carbon-footprint, as well as, reduction of greenhouse gasses are known to those of skill in the art of global warming mitigation. These parameters would include for example: 1 cubic yard of cement (3900 lbs) represents around 400 lbs of carbon dioxide.

In general, embodiments of the present inventions provide one or more of, the following:
1) Hydraulic throughput = more through the same equipment - we have demonstrated 200 \+% more.
2) Organic capacity = more through the same equipment 40-200% AND has required no additional aeration = less energy per mass of organics treated = smaller footprint (we believe the process increases oxygen transfer efficiency - See Case Study for Pulp and Paper).
3) Improve settleability of biomass therefore reduce recycle rates and therefore electricity and hence carbon footprint lower.
4) Improved denitrification = increased energy recovery because nitrate is used instead of oxygen for conversion of organics.
5) Improved phosphate removal eliminates costly chemicals which have high carbon footprint.
6) Biosolids (e.g., sludge):
   a) Reduce biosolids production from aeration basin by up to 70% (without optimization 20-30%+) = no downstream processing, less chemicals = less carbon footprint; this is directly proportional
   b) Advanced Digestion:
      i. Class B, A or AA or meeting low fecal limits without additional capital (no carbon footprint)
      ii. Improved nutrient value and less of it; or,
      iii. Years/months without disposal.

In general, embodiments of the present inventions can provide one or more of, the following:
1. Reduce use of concrete = increase capacity without concrete
2. Reduce power usage for pumping & aeration = better settleability of biomass and better oxygen transfer efficiency;
3. Reduce the mass of biosolids = reduce in the aeration basin in-situ = cut transportation and all downstream processing; reduce mass to land

The following examples are provided to illustrate various embodiments of the present systems and methods of the present inventions. These examples are for illustrative purposes, may be prophetic, and should not be viewed as limiting, and do not otherwise limit the scope of the present inventions.

### Example 1

In an embodiment the microbiology population of a wastewater treatment system is controlled through the use of an active treatment batch approach, e.g., Biofermentation®, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and nutrients such as nitrogen (N) and phosphorus (P). This use of an active treatment batch approach significantly improves biomass settleability allowing a wastewater treatment plant to minimize effluent turbidity, minimize total-P, and maximize Mean Cell Residence Time (MCRT), which results in more stable phosphorus removal. This embodiment reduces the pollutants in the effluent, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help achieve national, regional and global regulatory and organizational zero, or low, carbon guidelines, rules or standards. The active treatment batch approach process grows microbes on-site using, a side-stream reactor which routinely injects these microbes directly into the aeration basin, RAS (return activated sludge) line, anoxic zone of the wastewater plant, and combinations and variations of these. Or where the treatment batch is delivered to site as a liquid which can be concentrated to reduce volume for delivery up to 2X, up to 5X, up to 10X, up to 20X, up to 40X or up to 400X or combinations thereof. This liquid or concentrate is then added as described above within 24 hours of manufacture, within up to 48 hours of manufacture, within up to 72 hours of manufacture or within one week of manufacture or variations thereof. This significantly improves biomass settleability and phosphorus uptake, allowing the wastewater system to reach its full, healthy potential.

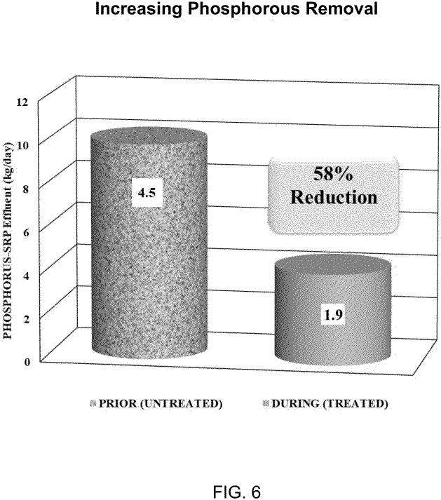

Turning to FIG. 6 there is shown the reduction in P. This active treatment batch approach provides a revenue positive solution with no increased CAPEX, no increased OPEX. Significantly, the active treatment batch approach, provides significant carbon dioxide (CO₂) savings by eliminating capital expansion costs and secondly by reducing biosolids production by 25% or more, 50% or more 60% or more, from about 25% to about 70%, about 40%, about 50%, about 60% in-situ, while still retaining the phosphorus in the residual biosolids. This reduction in biosolids and reduction in P are achieved in conjunction with at least a 20% lower, at least a 40% lower, at least a 100% lower, at least a 50% lower, and a 40% to 70% lower carbon-footprint when compared to prior approaches that would have to be added to and operated (i.e., additional energy usage) to even approach the above reduction in biosolids production (e.g., 60+% reduction) and reduction in P that the active treatment batch approach obtains.

### Example 2

In an embodiment the microbiology population of a wastewater treatment system is controlled through the use of an active treatment batch approach, e.g., Biofermentation°, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach significantly controls filamentous growth and improves floc structure allowing a wastewater treatment facility to maximize Mean Cell Residence Time (MCRT) and hence process more organic load and flow per unit volume. This embodiment provides this improved through put and maintains the required low levels of pollutants in the effluent, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This significantly improves biomass settleability allowing the wastewater system to reach its full, healthy potential by treating 125 \+% of design capacity and hydraulically 150 \+% surges.

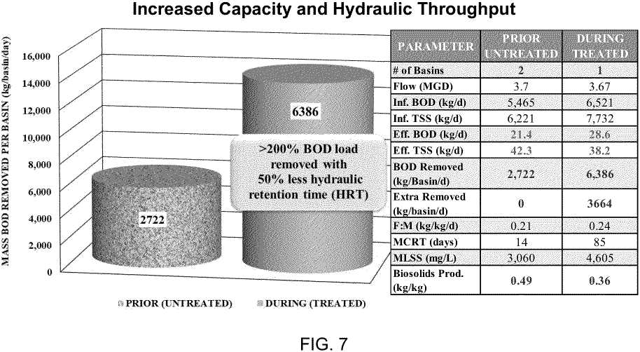

Turning to FIG. 7 there is shown this increase in capacity and hydraulic through put. This active treatment batch approach provides a revenue positive solution with no increased CAPEX, no increased OPEX. Significantly, the active treatment batch approach, provides significant carbon dioxide (CO2) savings by eliminating capital expansion costs and secondly by reducing biosolids production by 25% or more, 50% or more 60% or more, from about 25% to about 70%, about 40%, about 50%, about 60% in-situ, while increasing capacity and hydraulic throughput. This reduction in biosolids and increased throughputs are achieved in conjunction with at least a 20% lower, at least a 40% lower, at least a 100% lower, at least a 50% lower, and a 40% to 70% lower carbon-footprint when compared to prior approaches that would have to be added to and operated (i.e., additional energy usage) to even approach the above reduction in biosolids production (e.g., 60+% reduction) and increases in capacity and hydraulic throughput that the active treatment batch approach obtains.

### Example 3

In an embodiment the microbiology population of a wastewater treatment system is controlled through the use of an active treatment batch approach, e.g., Biofermentation°, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach controls filamentous growth allowing nitrification where the minimum Mean Cell Residence Time (MCRT) of 8 days for nitrification may not be attainable due to poor settleability. Where cold weather and MCRT impacts the degree of nitrification, the MCRT can be increased to offset low growth rates of nitrifying organisms allowing a stable nitrification process. This embodiment provides this improved nitrification and denitrification, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This significantly improves biomass settleability and nitrification and denitrification, allowing the wastewater system to reach its full, healthy potential.

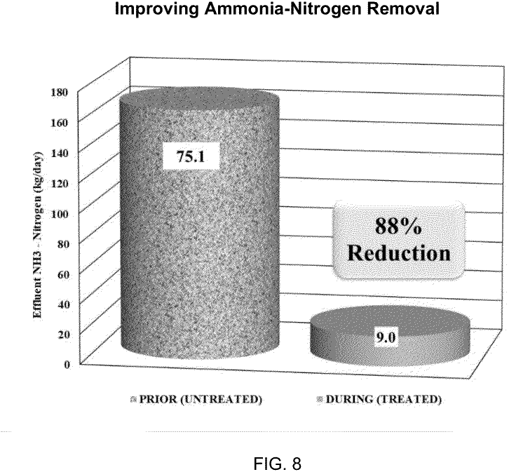

Turning to FIG. 8 there is shown this improved ammonia-nitrogen removal. This active treatment batch approach provides a revenue positive solution with no increased CAPEX, no increased OPEX. Significantly, the active treatment batch approach, provides significant carbon dioxide (CO2) savings by eliminating capital expansion costs and secondly by reducing biosolids production by 25% or more, 50% or more 60% or more, from about 25% to about 70%, about 40%, about 50%, about 60% in-situ, while obtaining the improvements in ammonia-nitrogen removal. This reduction in biosolids and improved ammonia-nitrogen removal are achieved in conjunction with at least a 20% lower, at least a 40% lower, at least a 100% lower, at least a 50% lower, and a 40% to 70% lower carbon-footprint when compared to prior approaches that would have to be added to and operated (i.e., additional energy usage) to even approach the above reduction in biosolids production (e.g., 60+% reduction) and improved ammonia-nitrogen removal that the active treatment batch approach obtains.

### Example 4

In an embodiment the microbiology population of a wastewater treatment system is controlled through the use of an active treatment batch approach, e.g., Biofermentation°, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach improves floc structure allowing a wastewater plant to maximize Mean Cell Residence Time (MCRT) and hence process more organic loading rate and flow per unit volume. This embodiment provides this improved organic load and flow per unit volume, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This significantly improves biomass settleability and organic load and flow per unit volume, allowing the wastewater system to reach its full, healthy potential.

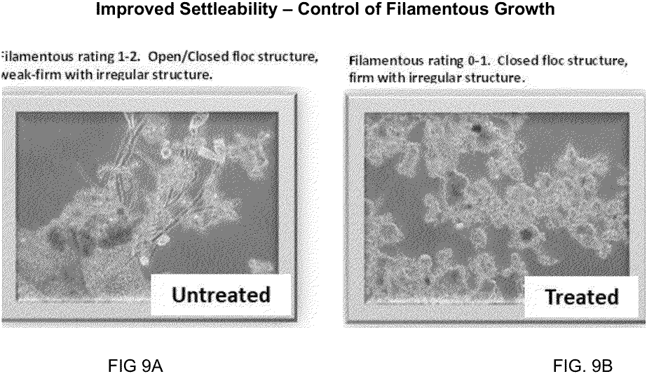

Turning to FIG. 9A (untreated) and 9B (active treatment batch application) there is shown this improved settleability and floc structure allowing maximization of MCRT and hence increase organic loading rate and flow per unit volume. This active treatment batch approach provides a revenue positive solution with no increased CAPEX, no increased OPEX. Significantly, the active treatment batch approach, provides significant carbon dioxide (CO₂) savings by eliminating capital expansion costs and secondly by reducing biosolids production by 25% or more, 50% or more 60% or more, from about 25% to about 70%, about 40%, about 50%, about 60% in-situ, while obtaining the improvements in ammonia-nitrogen removal. This reduction in biosolids and improved organic load and flow per unit volume are achieved in conjunction with at least a 20% lower, at least a 40% lower, at least a 100% lower, at least a 50% lower, and a 40% to 70% lower, carbon-footprint when compared to prior approaches that would have to be added to and operated (i.e., additional energy usage) to even approach the above reduction in biosolids production (e.g., 60+% reduction) and improved organic load and flow per unit volume that the active treatment batch approach obtains.

### Example 5

In an embodiment the microbiology population of a wastewater treatment system is controlled through the use of an active treatment batch approach, e.g., Biofermentation°, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach improves recovery of alkalinity (3- 3.6 mg/mg Nitrate) from denitrification in the anoxic zone or aeration basin. Alkalinity is often limited, but necessary for full nitrification to occur (7.14 mg CaCOs per mg ammonia oxidized). When alkalinity recovery occurs in the aeration basin, this is an indicator of simultaneous nitrification and denitrification (SND), efficiently producing 25% lower biosolids with 25% reduced aeration. This embodiment provides this improved organic load and flow per unit volume, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This significantly improves nitrate-nitrogen removal, allowing the wastewater system to reach its full, healthy potential.

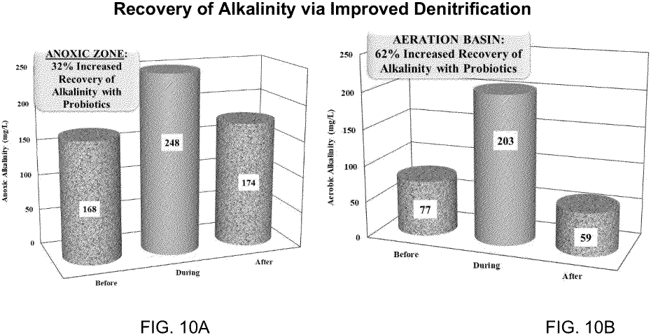

Turning to FIGS. 10A and 10B there is shown this improved nitrate-nitrogen removal with concomitant recovery of alkalinity. This active treatment batch approach provides a revenue positive solution with no increased CAPEX, no increased OPEX. Significantly, the active treatment batch approach, provides significant carbon dioxide (CO₂) savings by eliminating capital expansion costs and secondly by reducing biosolids production by 25% or more, 50% or more 60% or more, from about 25% to about 70%, about 40%, about 50%, about 60% in-situ, while obtaining the improvements in nitrate-nitrogen removal. This reduction in biosolids and improved nitrate-nitrogen removal are achieved in conjunction with at least a 20% lower, at least a 40% lower, at least a 100% lower, at least a 50% lower, and a 40% to 70% lower, carbon-footprint when compared to prior approaches that would have to be added to and operated (i.e., additional energy usage) to even approach the above reduction in biosolids production (e.g., 60 \+% reduction) and improved nitrate-nitrogen removal that the active treatment batch approach obtains.

### Example 6

In an embodiment the microbiology population of a wastewater treatment system is controlled through the use of an active treatment batch approach, e.g., Biofermentation^{Ⓡ}, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach reduces FOG and odors in the collection system. The liquid treatment batch is applied twice daily at wet wells and lift stations in the collection network using a dedicated feed system. This embodiment provides this improved organic load and flow per unit volume, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This significantly improves FOG and odor reduction, allowing the wastewater system to reach its full, healthy potential.

This active treatment batch approach provides a revenue positive solution with no increased CAPEX, no increased OPEX. Significantly, the active treatment batch approach, provides significant carbon dioxide (CO2) savings by eliminating capital expansion costs while obtaining the improvements in FOG and odor reduction .

This improvements in FOG and odor reduction are achieved in conjunction with at least a 20% lower, at least a 40% lower, at least a 100% lower, at least a 50% lower, and a 40% to 70% lower, carbon-footprint when compared to prior approaches that would have to be added to and operated (i.e., additional energy usage) to even approach the above improvements in FOG and odor reduction that the active treatment batch approach obtains.

### Example 7

In an embodiment the microbiology population of a wastewater treatment system is controlled through the use of an active treatment batch approach, e.g., Biofermentation^{Ⓡ}, adding a liquid treatment batch of living microbials (e.g., floc forming microbes, Pseudomonas, Pseudomonas putida, Bacillus, Bacillus subtilis, Bacillus, Bacillus subtilis, Pseudomonas , e.g., Pseudomonas putida, Nocardia, etc.) to the wastewater systems at any number of addition points, and thereby control and predetermine the living consortium of microbes (e.g., bacteria) that removes biological oxygen demand (BOD) and excess biological solids. This use of an active treatment batch approach provides one or more, and preferably all of biomass settleability, increase in capacity and hydraulic throughput, improve removal of nitrogen and phosphorus, reduce the burden of dewatering, processing, and disposing of biosolids by creating USA Class A/AA residuals or International equivalent standards. This embodiment provides these improved operation parameters, while not increasing the carbon-footprint of the facility.

This breakthrough provides a paradigm shift, breaking the prior paradigm of increasing effluent purity being tied to increasing greenhouse gas production. This shift, which is provided by the present inventions, meets a longstanding need of wastewater facilities, in order to respond to current regulatory and funding limitations the industry faces today and to help meet national, regional and global regulatory and organizational zero, or low, carbon guidelines, rules or standards. The active treatment batch approach process grows microbes on-site using, a side-stream reactor which routinely injects these microbes directly in to the aeration basin, RAS (return activated sludge) line, anoxic zone of the wastewater plant, and combinations and variations of these. This provides these improved operation parameters, allowing the wastewater system to reach its full, healthy potential.

This active treatment batch approach provides a revenue positive solution with no increased CAPEX, no increased OPEX. Significantly, the active treatment batch approach, provides significant carbon dioxide (CO2) savings by eliminating capital expansion costs and providing these improved operation parameters. These improved operation parameters are achieved with a 25%+ (i.e., 25% or more) lower, carbon-footprint when compared to prior approaches that would have to be added to and operated (i.e., additional energy usage) to even approach the above improved operation parameters that the active treatment batch approach obtains. These operating parameters are summarized in Table 3.

TABLE 3

| Problems and Solutions | Improvement | Reduced CO₂ emissions |
|---|---|---|
| Increased PE Capacity | 125%+ | 25-40%+ |
| Reduced CAPEX Requirement | 50%+ | 25-40%+ |
| Reduced OPEX Requirement | 20%+ | 25-40%+ |
| Reduced Energy Requirement | 10-20%+ | 25-40%+ |
| Increased Hydraulic Capacity | 125-150%+ | 25-40%+ |
| Increased Organic Capacity | 125-150%+ | 25-40%+ |
| Reduced Nitrogen | 50%+ | 25-40%+ |
| Reduced Phosphorus | 50%- | 25-40%+ |
| Reduced Biosolids (Sludge) | 60%+ | 25-40%+ |
| Class A Residuals (USA) | Optional benefit | 25-40%+ |

### Example 8

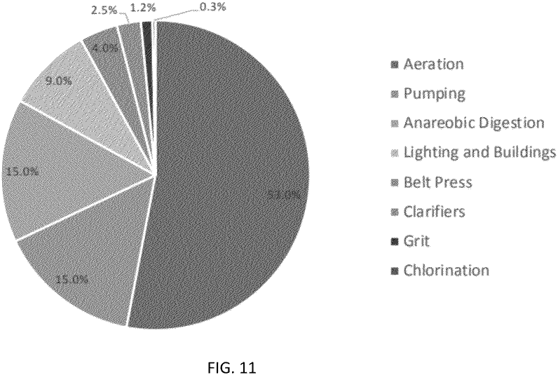

In an embodiment the breakout of energy consumption by process for a wastewater treatment plan (about 100+ MG) is showing in FIG. 11. It can be seen that aeration for biodegradation of soluble organics is 53% (180.2GWh/year) of the total energy consumption. The handling of residual biosolids by anaerobic digestion and belt presses is about another 19% (64.6GWh/year).

The volume of a treatment batch added to a particular treatment system is dependent on flow, PE, both organic and hydraulic loading rate, the rapidity or response required, the challenges faced, industrial discharges at municipal plants severely increased apparent load, the presence of toxicity or toxic compounds killing the existing biology, results desired and the concentration of liquid being applied and the type of plant. For example, activated sludge plants with MCRT’s of greater than 7 days the treatment batch can be applied weekly, whereas a single pass lagoon should be added continuously for best results, while a trickling filter would need to be added daily. As previously mentioned, the concentration of a treatment batch can vary from 1x, to 400x and so volumes can vary accordingly. In general, using 4x as a basis the volumes for treating 1 MGD of flow would be between 100 and 400 gallons per week. For a PE of 14,500 a dosing rate of between 1,500-5,000 litres per week at 4x is effective.

Using an embodiment of the present active treatment batch methodologies and technologies power consumption for aeration can be reduced by 25% (45 GWh/year) and power consumption for biosolids processing handling can be reduced by 60% (38.7 GWh/year), lowering electrical consumption by 83.7 GWh/year or 25% of overall electrical consumption, and thus reducing the greenhouse gasses for the generation of this electricity. Furthermore, the overall processing, handling, and disposal of biosolids can represent as much as 30-40% of the operating budget of a utility. The present inventions address these problems and reduce the carbon footprint for all these processes from 20% to 60%, and potentially more, as well as reducing the need for new capital investment. Further, the embodiments provide the ability to eliminate all CAPX without no increase in Carbon footprint

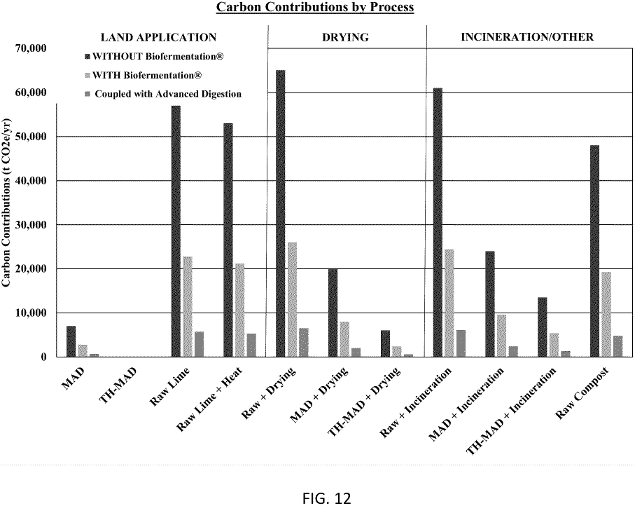

These embodiments can reduce carbon footprint and Nitrous Oxide (NOX), as shown in FIG. 12. Using the total carbon footprint of all 11 traditional processes and disposal methods compared in FIG. 12, the average carbon footprint is approximately 32,000-ton CO₂ emissions per year. Thus, the embodiment of this example would reduce CO₂ emissions per year comparable to 11,509 SUVs off the road annually.

### Example 9

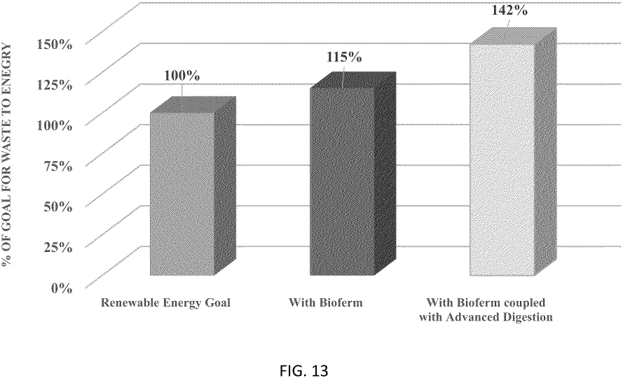

In an embodiment of a treatment facility and operation using active treatment batch methodologies and technologies would be operated under the parameters shown in FIG. 13

### Example 10

A wastewater treatment facility can be constructed to operate, or an existing wastewater facility can be operated under the conditions of one or more and preferably all of Examples 1 to 9.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments set forth in this specification, including dosing amounts and rates, microbe ages, microbe addition points, may be used with each other, in any one or more of the examples, in any one or more of the embodiments and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A method of increasing a capacity of a wastewater treatment facility, while maintaining the quality of the effluent, and without increasing a carbon footprint of the wastewater treatment plant, the method comprising:
a. determining an initial flow rate of a wastewater treatment facility; the wastewater treatment facility having an embodied carbon footprint; wherein the initial flow rate is at a capacity of the embodied carbon footprint to maintain the pollutants in an effluent from the wastewater treatment plant at or below a first level of pollutants; and,
b. increasing the flow rate of the wastewater treatment facility to provide an increased flow rate, wherein the increased flow rate is at least 25% greater than the initial flow rate;
c. wherein the level of pollutants in the effluent are maintained at or below the first level of pollutants at the increased flow rate; and,
d. wherein, the embodied carbon footprint of the wastewater treatment facility remains the same.

2. The method of claim 1, wherein the increased flow rate is at least 20% greater than the initial flow rate.

3. The method of claim 1, wherein the increased flow rate is at least 50% greater than the initial flow rate.

4. The method of claim 1 wherein the increased flow rate is at least 70% greater than the initial flow rate.

5. The method of claim 1 wherein the amount of biosolids produced from treating the initial flow rate to the increased flow rate is reduced by at least 25%.

6. The method of claim 1 wherein the amount of biosolids produced from treating the initial flow rate to the increased flow rate is reduced by at least 50%.

7. The method of claim 1 wherein the amount of biosolids produced from treating the initial flow rate to the increased flow rate is reduced by at least 60%.

8. The method of claim 1 wherein the amount of phosphorous produced from treating the initial flow rate to the increased flow rate is reduced by at least 20%.

9. The method of claim 1 wherein the amount of phosphorous from treating the initial flow rate to the increased flow rate is reduced by at least 50%.

10. The method of claim 1 wherein the amount of nitrogen produced from treating the initial flow rate to the increased flow rate is reduced by at least 20%.

11. The method of claim 1 wherein the amount of nitrogen from treating the initial flow rate to the increased flow rate is reduced by at least 50%.

12. A method of operating a wastewater treatment facility, to reduce the production of greenhouse gasses associated with the treatment of the wastewater, while maintaining the quality of the effluent, and without reducing the capacity of the wastewater treatment plant, the method comprising:
a. the wastewater treatment facility producing a first amount of greenhouse gasses for the treatment and disposal of sludge having for an initial flow rate of the wastewater treatment; wherein the pollutants in an effluent from the wastewater treatment plant are maintained at or below a first level of pollutants; and,
b. reducing the first amount of greenhouse gasses produced by at least 25%, while maintaining the level of pollutants in the effluent at or below the first level of pollutants.

13. The method of claim 12, wherein the greenhouse gasses are reduced by at least 30%.

14. The method of claim 12 wherein the greenhouse gasses are reduced by at least 40%.

15. The method of claim 12 wherein the greenhouse gasses are reduced by at least 60%.

16. The method of claim 12 wherein the greenhouse gasses are reduced by at least 80%.

17. The method of claim 12 wherein the amount of biosolids produced from treating the initial flow rate to the increased flow rate is reduced by at least 50%.

18. The method of claim 12 wherein the amount of biosolids produced from treating the initial flow rate to the increased flow rate is reduced by at least 60%.

19. The method of claim 12 wherein the amount of phosphorous produced from treating the initial flow rate to the increased flow rate is reduced by at least 20%.

20. The method of claim 12 wherein the amount of phosphorous from treating the initial flow rate to the increased flow rate is reduced by at least 50%.

21. The method of claim 12 wherein the amount of nitrogen produced from treating the initial flow rate to the increased flow rate is reduced by at least 20%.

22. The method of claim 12 wherein the amount of nitrogen from treating the initial flow rate to the increased flow rate is reduced by at least 50%.

23. A method of providing green sustainable microbiology net zero carbon solution to waste water and waste material treatment using biofermentation to treat the waste water and waste material with a treatment containing biofermented microbes.

24. The method of any of claims 1, 12 or 23 comprising the treatment of fats, oils and grease.

25. The method of any of claims 1, 12 or 23 comprising increasing alkalinity recovery by improving denitrification.

26. The method of any of claims 1, 12 or 23 comprising improving biomass settleability.

27. The method of any of claims 1, 12 or 23 comprising control of undesirable filamentous growth.

28. The method of any of claims 1, 12 or 23 comprising improving nitrification and increasing ammonia removal.

29. The method of any of claims 1, 12 or 23 comprising re-rating wastewater plants.

30. The method of any of claims 1, 12 or 23 comprising increasing capacity and hydraulic throughput of wastewater plants.

31. The method of any of claims 1, 12 or 23 comprising increasing phosphorus removal.

32. The method of any of claims 1, 12 or 23 comprising minimizing opex costs.
